(19) United States
(12) Patent Application Publication
(10) Pub. No.: US 2009/0296574 A1
(43) Pub. Date: Dec. 3, 2009

(54) TRAFFIC LOAD DEPENDENT POWER ALLOCATION IN MULTI USER WIRELESS COMMUNICATION NETWORK WITH PROPORTIONAL FAIR SCHEDULING IN TIME AND FREQUENCY DOMAIN

(76) Inventors: Jingyi Liao, Beijing (CN); Lei Wan, Beijing (CN)

Correspondence Address: ERICSSON INC., 6300 LEGACY DRIVE, M/S EVR 1-C-11, PLANO, TX, 75024, US

(21) Appl. No.: 12/297,554

(22) PCT Filed: Apr. 18, 2006
(86) PCT No.: PCT/SE06/00457

§ 371 Date: Jul. 15, 2009

(51) Int. Cl. H04L 12/24

(52) U.S. Cl. 370/230

(57) ABSTRACT

A method of allocating resources in a wireless multi-user network is disclosed, comprising the following steps: —performing a proportional fair scheduling in time and frequency domain based on the bitrate for each user and the channel quality measurements for each chunk per user; and—performing a power allocation in the following way: o if the traffic load is above a threshold: allocating the uniform power to all subcarriers o if the traffic load is below the threshold, adapting a channel-dependent power allocation scheme.

### TECHNICAL FIELD

The present invention relates to a communication method and apparatus, and in particular to a scheduling method for multi-user wireless communication networks.

### BACKGROUND AND PRIOR ART

Multi-user wireless communication networks are being used to an increasing degree and offer an increasing number of services. Such networks include Orthogonal Frequency Division Multiplex (OFDM) and Orthogonal Frequency Division Multiple Access (OFDMA) systems.

An important function in all multi-user wireless communication networks is the allocation of resources to different users in the network. Ideally, this should be achieved in such a way that each user gets a fair share of the network resources depending on the type of service requested, the type of subscription and other parameters.

An important type of multi-user wireless communication networks is Orthogonal Frequency Division Multiplex (OFDM) based communication systems. In multi-user OFDM a number of users share one symbol to provide multiple access. In OFDM systems the available transmission bandwidth is divided into a set of narrowband subcarriers. A set of neighbouring subcarriers, which is the minimum allocated radio resource, is often referred to as a chunk. In a multi-user OFDM system, known as Orthogonal Frequency Division Multiple Access (OFDMA) different sub-carriers can be allocated to different users so as to provide a flexible multi-user access scheme. To improve the efficiency adaptive resource allocation techniques are used. In the adaptive OFDM downlink, packet data streams to a number of active users are multiplexed on a common bandwidth. Each user must estimate and (or) re-port the signal to interference and interference ratio (SINR) for its potentially used spectrum. A radio resource management module then allocates time-frequency resource and power based on the requirements and channel qualities of each user.

Several techniques have been proposed for exploiting the high degree of flexibility of radio resource management in OFDM by allocating resources between the users in the OFDM network in a fair manner. Data rate adaptation over all the subcarriers or a chunk, for example dynamic subcarrier/chunk assignment and adaptive power allocation can be employed.

U.S. Pat. No. 6,807,426 proposes a fair scheduling scheme to apply a variety of combinations of channel condition metrics and user fairness metrics which has been used for WCDMA systems. A sequential scheduler is proposed, that is, first one user selects its active subcarriers/chunks and then the other users can select among the ones that are left. The sequential scheduler is complicated and rather slow. Users can be divided into classes to assign different priorities to users.

U.S. Pat. No. 6,947,748 proposes subcarrier/chunk selection in which each of multiple subscribers measure channel and interference information for subcarriers based on pilot symbols received from a base station. The base station allocates subcarriers to each subscriber based on the channel and interference information. This allocation scheme has not taken fairness and coverage performance into consideration.

Other studies focus on joint subcarrier/chunk allocation and power allocation in which, typically, subchannel allocation is first performed by assuming an equal power distribution, then an optimal power allocation algorithm is applied in order to maximize the sum capacity while maintaining proportional fairness. Such systems are proposed in, for example, Zukan Shen, Andrews, J. G.; Evans, B. L. “Optimal power allocation in multiuser OFDM systems”, GLOBECOM '03 IEEE, December 2003 and Guocong Song and Ye (Geoffrey I Li, “Adaptive subcarrier and power allocation in OFDM based on maximizing utility”, Vehicular Technology Conference, 2003. VTC 2003-Spring. The 57^{th} IEEE Semi-annual, Volume 2, 22-25 Apr. 2003.

The frequency domain adaptation methods outlined above are subject to constraints on total power, bit error rate and proportionality among user data rates.

From a point of view of diversity the multi-user diversity and frequency diversity results from adaptive subcarrier/chunk allocation. Besides, adaptive power allocation in the frequency domain can also enhance system performance by means of frequency diversity. The subcarrier/chunk allocation and power control schemes currently used or proposed have the following

### OBJECT OF THE INVENTION

It is an object of the invention to provide a joint scheduling and power allocation scheme for OFDM systems which takes both traffic load and system performance into consideration.

### SUMMARY OF THE INVENTION

This object is achieved according to the present invention by a control unit for use in a multi-user wireless communications network, said control unit comprising a processor and a computer program, for controlling resource allocation in the network, said control unit being characterized in that it is arranged to perform resource allocation in the network according to the following:
performing a proportional fair scheduling in time and frequency domain based on the bitrate for each user and the channel quality measurements for each chunk per user; and
performing a power allocation in the following way:
   if the traffic load is above a threshold: allocating the uniform power to all subcarriers
   if the traffic load is below the threshold, adapting a channel-dependent power allocation scheme.

The object is also achieved by a method of allocating resources in a wireless multi-user network, performing the following steps:
performing a proportional fair scheduling in time and frequency domain based on the bitrate for each user and the channel quality measurements for each chunk per user; and
performing a power allocation in the following way:
   if the traffic load is above a threshold: allocating the uniform power to all subcarriers
   if the traffic load is below the threshold, adapting a channel-dependent power allocation scheme.

The object is further achieved by a computer program product comprising computer-readable code means, which, when run in a processor in a wireless multi-user communications network causes the processor to control the resource allocation in the multi-user communications network by
performing a proportional fair scheduling in time and frequency domain based on the bitrate for each user and the channel quality measurements for each chunk per user; and
performing a power allocation in the following way:
   if the traffic load is above a threshold: allocating the uniform power to all subcarriers
      if the traffic load is below the threshold, adapting a channel-dependent power allocation scheme.

In the control unit, the method and the computer program product according to the invention, the purpose of the channel-dependent power allocation is to allocate the power among different chunks. In a multiple-antenna system, the channel-dependent power allocation can also allocate the power among different streams in spatial-domain.

The channel-dependent power allocation scheme may be, for example, an on/off power allocation scheme as the channel-dependent power allocation scheme, or a water-filling based algorithm as the channel-dependent power allocation scheme.

The load-switched frequency domain processing according to the invention includes a serialized frequency domain processing, which provides good performance in capacity, coverage and fairness, and which reduces computation complexity especially for heavy traffic loads, without losing system performance.

The proportional fair scheduling in both the time and the frequency domain (PFTF) is an extension of the proportional fair (PF) scheduling in the frequency domain. The PFTF scheduler maintains resource fairness by providing a fair sharing of transmission time on each chunk proportional to the past throughputs of each user individually, over a fixed window length. At the same time the chunk-wise independent scheduler used according to the invention is less complicated than the sequential frequency-domain scheduler. The main difference between the PFTF and the PF proposed in U.S. Pat. No. 6,807,426 is that PF is done per OFDM frame with the same granularity of throughput measurement whereas PFTF treats the chunks as independent series scheduling units but update throughput measurement per OFDM frames. If Tₖ(n) is taken as a common value for all users the PFTF could be the maximum SNR scheduling scheme.

The traffic load based power control according to the invention will reduce computation complexity, especially in cases of heavy traffic load.

### BRIEF DESCRIPTION OF THE DRAWINGS

The invention will be described in more detail in the following, by way of example and with reference to the appended drawings in which:

FIG. 1 is an overview of a wireless communication network in which the invention may be employed,

FIG. 2 is a flow chart of the method according to the invention,

FIGS. 3a and 3b show results of simulations of the inventive method

### DETAILED DESCRIPTION OF EMBODIMENTS

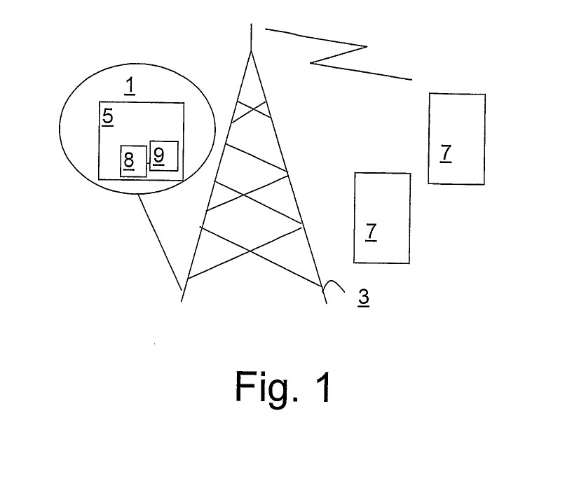

FIG. 1 shows a cellular telecommunications network 1 in which the principles of the present invention may be applied. A base station 3 communicating with on or more control units 5 in the network also communicates with a number of user terminals 7 in the cell through a wireless interface. A main problem in cellular communications networks is how to achieve a fair distribution of resources between all the users 7 in the network. The control unit 5 comprises a processor 8 and a memory 9 holding computer software for controlling the resource allocation according to the invention, as will be discussed in the following.

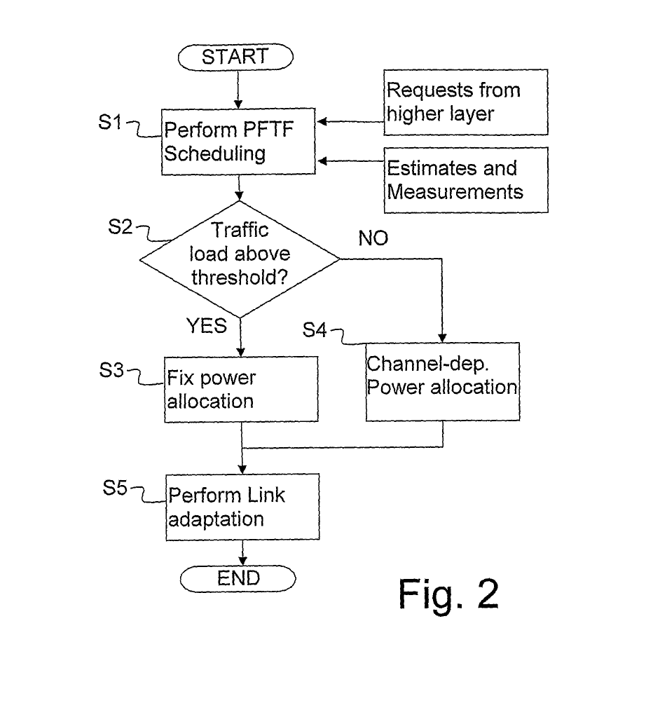

FIG. 2 is a flow chart of the method according to the invention. In step S1 a PFTF scheduling is performed as will be discussed in more detail below. Step S2 is a decision step in which it is determined if the traffic load is above or below a threshold. The threshold could be the number of active users' (or offer calls') in one frame (or TTI), where the active users are allocated to different radio resources in the frequency domain. The number is pre-defined for different scenarios. Alternatively, it could be the CQI threshold, or its related mutual information or throughput. If the threshold is only the number, the threshold computation complexity is only O(1). If another threshold, such as CQI threshold, is used, the computation becomes more complex, O (M), where M is the total available frequency chunks. The threshold may be calculated by the control unit or may be predefined and stored in a memory, for example the memory 9.

If the traffic load is above the threshold, in step S3, a fixed power allocation is adopted regardless of the channel's condition, which allocates the total power among all subcarriers uniformly. If the traffic load is below the threshold, in step S4 a channel-dependent power allocation scheme is applied to all the active users in order to increase the frequency diversity gain. The channel-dependent power allocation scheme could be set on or off for each chunk as will be discussed in more detail below. From each of step S3 and S4 the procedure continues with step S5.

In step S5 link adaptation is worked for data related to each user. The link adaptation includes selection of Modulation and Coding Scheme (MCS) and other functions.

The PFTF scheduling performed in step S1 requires two inputs. One is the correctly transmitted bit-rate for each user, updated per frame. The other one is the channel quality measurements per chunk for each user. Compared to the traditional PF scheduler more dense channel quality measurements are required. PFTF implements the multi-user scheduler chunk-by-chunk, which means that the decision for each chunk is independent of the other chunks, in contrast to the sequential frequency-domain scheduler.

The proportional fair scheduling in both time and frequency domain (PFTF) applied according to the invention is an extension of proportional fair scheduling in the frequency domain. The PFTF scheduler maintains resource fairness according to a fair metric of information transmission capability estimation of the link between the access-point and each user in proportion to the past throughputs of users over a fixed window length. The information transmission capability is estimated based on the channel quality (CQ) feedback from each user, while the past throughput per user can be collected either in the access-point or in the UE. On the time-frequency re-source forward link transmission, at each time-frequency chunk 72 for time slot k, the control unit 5 obtains a parameter Ri,k(n) which may be requested data rate or one or more other estimated parameters, for example estimated SNR or delay, on chunk n for user i, which is supportable by its current channel quality. Assuming an instantaneous and error-free information feedback for slot k, the scheduler assigns the time-frequency chunk n to the user i, which has the largest ratio

$$\frac{{R}_{i , k} ( n )}{{T}_{k} ( n )}$$

where Tₖ(n) is average throughput or other measured parameter of chunk n for user number k in a past window.

Load switched power allocation is performed as follows: If the traffic load is above a threshold a fixed power allocation is adopted regardless of the channel condition of each channel. The power is allocated to all subcarriers uniformly. The fixed power allocation has the smallest computation complexity O(1). If the traffic load is lower than the threshold a channel-dependent power allocation scheme is adopted in order to increase the frequency diversity gain. The basic principle is based on the fact that both channel-dependent scheduling and power allocation can be used to achieve multi-user diversity and frequency diversity gain for the system. Therefore, if sufficient multi-user diversity gain has already been achieved by scheduling, only a small improvement can be achieved by power allocation. Since the improvement that can be achieved by power allocation is very small, power allocation is preferably not used in this case. The frequency domain scheduling (for example, PFTF) achieves a better performance if more users are scheduled at the same time since this enables more diversity gain.

The power allocation scheme according to the invention could be channel dependent or channel independent. Channel independent power allocation scheme could be to allocate equal power to all chunks. Channel dependent power allocation schemes desire to achieve better performance, for example, better capacity, based on the known channel information and the quality model.

A channel dependent power allocation scheme that could be used is multi-user on/off power allocation, where the chunks set “on” per user have the same flat power distribution. Multi-user on/off power allocation includes two steps:

First a power Pᵢ is allocated to each user i, assuming M is the total number of available frequency chunks and Mᵢ is the allocated chunks to user i after PFTF scheduling. This can be expressed as

$${P}_{i} = \frac{{M}_{i}}{M} {P}_{total}$$

Secondly, the power Pᵢ is allocated to the used chunk n of user i to obtain the maxi-mum throughput for user i.f(•) is a mapping function of SNR to throughput that is, to obtain the maximum throughput for user i the power Pᵢ is allocated to all the selected chunks of user I by means of an on/off scheme.

$${arg max}_{{Y}_{i} ⊆ {Y}_{i}} {\sum }_{, n ∈ {Y}_{i}^{′}} ( {R}_{i} ( n ) ) = {arg max}_{{Y}_{i} ⊆ {Y}_{i}} {\sum }_{, n ∈ {Y}_{i}^{′}} f ( {g}_{i} ( n ) \cdot {P}_{i} ( n ) )$$

which is to select “on” chunks based on estimated SNR gᵢ(n) information, where Yᵢ is the chunk set used by user i. The final selected “on” chunks set Y′ᵢ⊂Yᵢ.

$${P}_{i} ( n ) = \{ \begin{matrix}\frac{{P}_{user \_ i}}{{M}_{i}^{on}} & chunk {n }^{′} {on}^{′} , n ∈ {Y}_{i}^{′} \\ 0 & { }^{′} {off}^{′}\end{matrix}$$

Other power allocation schemes could also be used, for example, the water-filling based scheme described in Zukan Shen, Andrews, J. G.; Evans, B. L. “Optimal power allocation in multiuser OFDM systems”, GLOBECOM '03 IEEE, December 2003. The water-filling method, like the on/of power allocation mentioned above, is also based on channel information to perform optimal or suboptimal power allocation to achieve a good capacity gain. The water-filling method could achieve the best performance with Shannon capacity, but not for real modulation systems, since there is a mutual information gap between the Shannon capacity and the capacity for real modulation (for example QPSK, 16QAM).

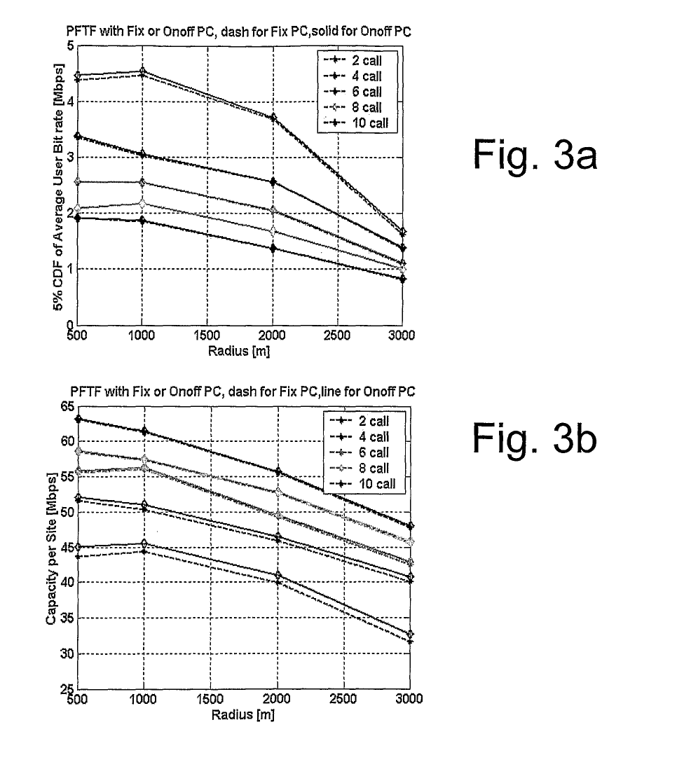

FIGS. 3a and 3b show results of a simulation of the inventive method performed with the following assumptions:
a power of 80 W is allocated for 20 MHz
full buffer traffic
continuous coding rate adaptation
a single transmitter and receiver antenna
the same MCS for the same user to an OFDM frame.

In FIGS. 3a and 3b the results for PFTF with fix power control are shown as dashed lines and the results for on/off power control are shown as solid lines. From top to bottom in the curves the pairs of lines represent the results for 2, 4, 6, 8 and 10 calls, respectively.

FIG. 3a shows PFTF with fix power control and on/off power control, for 2, 4, 6, 8 and 10 calls, respectively. The x axis represents the radius, ranging from 500 meters to 3000 meters, and the y axis represents 5% CDF of average user (at the cell edge) bit rate in Mb/s. In FIG. 3b, the x axis represents the radius, ranging from 500 meters to 3000 meters, and the y axis represents the capacity per site in Mb/s. As can be seen, on/off power allocation is preferable for use together with PFTF when the number of offered calls is small. For example, comparing the cell throughput at a cell radius of 2000 meters, on/of power control has about 4% gain over fix power control. As the number of offered calls increases the additional gain of using on/off power allocation compared to fix power allocation is reduced. Therefore, it may be advantageous to use fix power allocation together with PFTF to reduce computation complexity.

1. A control unit for use in a multi-user wireless communications network, said control unit comprising a processor and a computer program, for controlling resource allocation in the network, said control unit being characterized in that it is arranged to perform resource allocation in the network according to the following:
performing a proportional fair scheduling in time and frequency domain based on the bitrate for each user and the channel quality measurements for each chunk per user; and
performing a power allocation in the following way:
if the traffic load is above a threshold: allocating the power uniformly to all sub-carriers
if the traffic load is below the threshold, adapting a channel-dependent power allocation scheme.

2. A control unit according to claim 1, arranged to determine the threshold for a given situation.

3. A control unit according to claim 1, arranged to obtain the threshold from a memory unit.

4. A control unit according to claim 1, arranged to determine the threshold based on the CQI threshold, or its related mutual information or throughput.

5. A control unit according to claim 1, arranged to assign to a first user a time-frequency chunk n having the largest ratio
$$\frac{{R}_{i , k} ( n )}{{T}_{k} ( n )}$$
where Tₖ(n) is average throughput or other measured parameter of chunk n for user number k in a past window.

6. A control unit according to claim 1, arranged to use an on/off power allocation scheme as the channel-dependent power allocation scheme.

7. A control unit according to claim 1, arranged to use a water-filling based algorithm as the channel-dependent power allocation scheme.

8. A method of allocating resources in a wireless multi-user network, comprising the following steps:
performing a proportional fair scheduling in time and frequency domain based on the bitrate for each user and the channel quality measurements for each chunk per user; and
performing a power allocation in the following way:
if the traffic load is above a threshold: allocating the power uniformly to all sub-carriers
if the traffic load is below the threshold, adapting a channel-dependent power allocation scheme.

9. A method according to claim 8, further comprising the step of determining the threshold based on the number of active users served in frequency domain.

10. A method according to claim 8, further comprising the step of determining the threshold based on the CQI threshold, or its related mutual information or throughput.

11. A method according to claim 8, further comprising obtaining the threshold value from a memory.

12. A method according to claim 8, comprising the step of assigning to a first user a time-frequency chunk n having the largest ratio
$$\frac{{R}_{i , k} ( n )}{{T}_{k} ( n )}$$
where Tₖ(n) is average throughput or other measured parameter of chunk n for user number k in a past window.

13. A method according to claim 8, wherein the channel-dependent power allocation scheme is an on/off power allocation scheme.

14. A method according to claim 8, wherein the channel-dependent power allocation scheme is a water-filling based algorithm.

15. A computer program product comprising computer-readable code means, which, when run in a processor in a wireless multi-user communications network causes the processor to control the resource allocation in the multi-user communications network by
performing a proportional fair scheduling in time and frequency domain based on the bitrate for each user and the channel quality measurements for each chunk per user; and
performing a power allocation in the following way:
if the traffic load is above a threshold: allocating the power uniformly to all sub-carriers
if the traffic load is below the threshold, adapting a channel-dependent power allocation scheme.

16. A computer program product according to claim 15, arranged to determine the threshold based on the number of active users served in frequency domain.

17. A computer program product according to claim 15, arranged to determine the threshold based on the CQI threshold, or its related mutual information or throughput.

18. A computer program product according to claim 15, arranged to assign to a first user a time-frequency chunk n having the largest ratio
$$\frac{{R}_{i , k} ( n )}{{T}_{k} ( n )}$$
where Tₖ(n) is average throughput or other measured parameter of chunk n for user number k in a past window.

19. A computer program product according to claim 15, arranged to use an on/off power allocation scheme as the channel-dependent power allocation scheme.

20. A computer program product according to claim 15, arranged to use a water-filling based algorithm as the channel-dependent power allocation scheme.
